(19) United States
(12) Patent Application Publication
(10) Pub. No.: US 2015/0220179 A1
(43) Pub. Date: Aug. 6, 2015

(54) CAPACITIVE TOUCH SCREEN AND DISPLAY DEVICE EQUIPPED THEREWITH

(71) Applicant: Japan Display Inc., Minato-ku (JP)

(72) Inventor: Yohei KIMURA, Minato-ku (JP)

(73) Assignee: Japan Display Inc., Minato-ku (JP)

(21) Appl. No.: 14/612,790

(22) Filed: Feb. 3, 2015

(30) Foreign Application Priority Data
Feb. 6, 2014 (JP) 2014-021558

(51) Int. Cl. G06F 3/044; G06F 3/041

(52) U.S. Cl. CPC G06F 3/044; G06F 3/0412; G06F 2203/04112

(57) ABSTRACT

According to embodiments, a touch screen comprises, in a touch screen area: an array of first direction touch electrodes; and an array of second direction touch electrodes, each extending in a second direction; each of the touch electrodes comprising a plurality of island pads and a plurality of bridges that serially connects the island pads; each of the island pads having dents on a fringe as shaped as a rectangular wave; a width of each of the dents and a distance between the dents are 0.5 to 1.5 times of a gap between adjacent ones of the island pads; and a depth of the dents being 1 to 3.5 times of the gap between the adjacent ones of the island pads.

### CROSS-REFERENCE TO RELATED APPLICATIONS

This application is based upon and claims the benefit of priority from the prior Japanese Patent Application No. 2014-21558, filed on Feb. 6, 2014; the entire contents of which are incorporated herein by reference.

### FIELD

Embodiments of the present invention relate to a capacitive touch screen and to a display device having such a touch screen.

### BACKGROUND

Touch screens, which had been used in ticket bending machines at railway stations and in automatic teller machines at banks, have become widely adopted in recent years, due to spread of smart phones and tablet PCs. The touch screens are widely used also in digital cameras and portable game machines for examples.

Among others, popular for smart phones and/or tablet PCs are projected-capacitive touch screens, which have touch electrodes formed of transparent conductive materials, because the projected-capacitive touch screens have high transmittance rate and high durability, and are able to deal with complicated input operations through multiple touches. The projected-capacitive touch screen comprises: an array of a plurality of first direction touch electrodes, each extending in a first direction (X direction); and an array of a plurality of second direction touch electrodes, each extending in a second direction (Y direction) that intersects the first direction (X direction). When a dielectric body such as a finger touches or gets close to a surface of the touch screen, a change in electrostatic capacitance at a touched position is detected by the first direction and second direction touch electrodes. Please see JP2013-016205A for example.

As varieties of the touch screens, there are: “external” ones, each being eventually attached onto a view-area face of an image display device such as a flat panel display device; and “built-in” ones, each being integrated with a display panel of the flat-panel display device to achieve light weight and thin profile. As varieties of the “built-in” ones, there are: “on-cell” touch screens, each being constructed on the view-area face; and “in-cell” touch screens, each being constructed in an interior of the display panel, specifically on inner surface of an array substrate.

Most typically, the flat-panel display devices equipped with the touch screens are active-matrix LCD (liquid-crystal display) devices and organic EL display devices. Such flat-panel display device generally comprises the display panel and a driver device. The LCD panel comprises an array substrate and a counter substrate, which are combined to each other, and a liquid crystal layer interposed between these substrates. The organic EL display device is typically obtained by: arranging an organic EL film on the array substrate, on which switching elements are arrayed; bonding the counter substrate to the array substrate through a sealing material (fill material); and curing the sealing material.

In the capacitive touch screens (the projected-capacitive touch screens in particular), in order to improve detection sensitivity, each of the touch electrodes in the first and second directions comprises: island pads, each having a rhombic shape or the like; and bridges, or conductive wires, that connect the island pads. In general, an electrode pattern is designed so that each of the island pads of the first direction touch electrodes does not overlap, and is disposed in close proximity to, adjacent ones of the island pads of the second direction touch electrodes. In other words, in a plan view, each of the island pads of the first direction touch electrodes is distanced by a relatively small gap, from adjacent ones of the island pads of the second direction touch electrodes.

On the other hand, it has been attempted to adopt metallic thin wires, instead of a transparent electrode material, for forming the first direction and second direction touch electrodes. Please see JP2012-079238A and JP2010-256981A for examples. JP2012-079238A proposes that, in order to achieve “good responsiveness even when the surface area is large, and multi-touch sensing” ([0004]), each of the island pads of the touch electrodes is formed by a mesh pattern, in which conductive thin wires are formed of a metal or a conductive paste are arranged in a square-lattice pattern. Please see FIGS. 3-5 for examples. Preferably, width of the conductive thin wires are “in a range from 0.5 μm to 10 μm”; and “side length of a lattice block of the mesh pattern is in a range from 100 μm to 600 μm” ([0034]). Meanwhile, JP2010-256981A proposes that, in order to achieve “applicability to a small-sized touch screen and low visibility from a user” ([0008]), the island pads are formed by arranging thin wires as “non-transparent conductive members”, in a zigzag folded manner.

When the metal thin wires are adopted for forming the island pads, it is required to arrange a blackening layer that covers only the metal thin wires so as to curb troubles of metallic color and shining. Please see JP2010-256981A, [0050]-[0053]. Hence, processes of metal sputtering or film formation and patterning are required, and manufacturing costs increases accordingly. If the ratio of covering with the metal thin wires is increased, light transmittance ratio decreases. Therefore, the covering ratio is not able to be increased, and hence the electrostatic capacitance is not able to be increased. Thus, there seems to be a limit in improvement of sensor sensitivity.

In view of the above, embodiments of the invention is aimed to curb visibility from user, of the island pads of the touch electrodes while maintaining performances such as sensor sensitivity and while curbing increase of manufacturing costs.

### BRIEF DESCRIPTION OF THE DRAWINGS

FIG. 1 is a plan view showing a pattern of touch electrodes, which is an essential part of a touch screen of an embodiment;

FIG. 2 is a plan view showing a pattern of a single island pad and portions continuing from the island pad, within the pattern of the touch electrode shown in FIG. 1;

FIG. 3 is a schematic cross-sectional view showing an example of a laminated construction of the touch screen that is shown in FIGS. 1-2;

FIG. 4 is a plan view in a manner of FIG. 2 and shows another pattern of the island pad according to a second embodiment; and

FIG. 5 is also a plan view in a manner of FIG. 2 and shows a still other pattern of the island pad according to a third embodiment.

### DETAILED DESCRIPTION

A touch screen according to a group of embodiments comprises, in a touch-screen area: an array of first direction touch electrodes, each extending in a first direction (X direction); and an array of second direction touch electrodes, each extending in a second direction (Y direction) that intersects the first direction (X direction); each of the touch electrodes comprising a plurality of island pads and a plurality of bridges that serially connects the island pads; each of the island pads having dents on a fringe as shaped as a rectangular wave; a width of each of the dents and a distance between the dents are 0.5 to 1.5 times of a gap between adjacent ones of the island pads; and a depth of the dents being 1 to 3.5 times of the gap between the adjacent ones of the island pads.

A touch screen according to other group of embodiments comprises, in a touch-screen area: an array of first direction touch electrodes, each extending in a first direction (X direction); and an array of second direction touch electrodes, each extending in a second direction (Y direction) that intersects the first direction (X direction); and each of the touch electrodes comprising a plurality of island pads and a plurality of bridges that serially connects the island pads; each of the island pads comprising a mesh pattern at least in vicinity of a fringe of the island pad; a width of each of openings in the mesh pattern being 0.25 to 1.3 times of a gap between the adjacent island pads; and line thickness or breadth of lines (to be referred to as “mesh line”) in the mesh pattern being 0.5 to 1.5 times of a gap between the adjacent ones of the island pads.

By each of the above two groups of embodiments, the island pads of the touch electrodes become less visible from a user while causing little increase in manufacturing costs and little decrease in sensor sensitivity.

In a preferred embodiment, each of the island pads of the touch electrodes except along a fringe of the touch-screen area has a rhombic or rhomboid shape, a rectangular or oblong shape, hexagonal shape, or other polygonal shape; and the gaps between the island pads are substantially constant. For example, a width of the widest portion of the gaps is two times or smaller of, preferably 1.7 times or smaller of, more preferably 1.5 times or smaller, or specifically 1.3 times or smaller of, a width of the narrowest portion of the gaps. The gaps between the island pads are normally within a range from 50 to 1000 μm, preferably from 100 to 500 μm, more preferably from 150 to 300 μm; and may be in a range normally from 1/200 to ⅕, specifically from 1/100 to 1/10, or from 1/50 to 1/15 for example, of a width (short diameter) of the island pads.

In preferred embodiments, a depth of the rectangular-wave-shaped dents are within a range from 0.8 to 4 times, preferably from 1 to 3.5 times, more preferably from 1.3 to 3 times, or from 1.5 to 2.5 times and for example, of the gaps between the island pads and/or of the widths of the dents. Distances between the adjacent dents preferably are within a range from 0.5 to 1.5 times, more preferably from 0.8 to 1.3 times, of the width of the dents. The widths of the dents and the distances between the dents may be gradually changed as it goes along a fringe of the island pad. Each of the rectangular-wave-shaped dents does not necessarily have a rectangular shape, and may have a trapezoidal shape and may be rounded at corners, as long as the widths and/or other dimensions are within the above ranges.

In preferred embodiments, within each of the island pads of the touch electrodes, a mesh pattern is formed by openings that are formed as lattice openings or slits, and are arrayed in the island pad. In preferred embodiments, the mesh pattern is formed at least on whole of a fringe part, that is, along a fringe throughout a whole circumference of each of the island pads. In a preferred embodiment, widths of the openings that form the mesh pattern are within a range from 0.25 to 1.3 times, preferably from 0.5 to 1.1 times, of the line thickness of the mesh lines (lines in the mesh pattern), and/or are within a range from 0.5 to 1.5 times, preferably from 0.8 to 1.3 times, of the gaps between the adjacent island pads. In another preferred embodiment, the width of the openings in the mesh pattern are within a range from 0.1 to 1.5 times, more preferably, from 0.8 to 1.3 times of the width of the dents.

This mesh pattern may be a latticework, in which the lines are arrayed to form an orthogonal grid, or may be a stripe pattern, in which the lines are arrayed in stripes. In other words, the mesh pattern may be of a pattern, in which mesh openings are arrayed in a direction along one edge of the island pad and in a direction along an edge adjacent to the one edge, of the island pad, to form a matrix; or may be a pattern, in which slits are arrayed in parallel with a nearby edge. Even when the openings are formed in non-fringe part or interior part of each of the island pads, a center part of the island pad may be formed as a solid pattern. A ratio of the solid pattern at the center part to a net surface area of the electrode in the island pad, or to whole surface area of the electrode excluding the openings and the dents in the island pad, may be in a range from 5 to 70% for example, or specifically from 10 to 50%.

When the touch screen is provided on a view area of an image display device, the touch electrode is formed of a transparent conductive material such as ITO (Indium Tin Oxide) and IZO (Indium Zinc Oxide). In general, after forming a film by sputtering or the like, a predetermined electrode pattern is formed by patterning using a photolithography. Each of the embodiments is applicable to the “external” touch screens and is equally applicable to the “integrated” touch screens, which include the “on-cell” ones and the “in-cell” ones as previously mentioned. The “external” touch screen has touch electrodes on the transparent insulation substrate, which is separate from substrates of the display panel. The touch electrodes may be constructed such that: the first direction touch electrodes extending in the first direction (X direction) are formed in first electrode layer, the second direction touch electrodes extending in the second direction (Y direction) are formed in a second electrode layer, and an insulating film is interposed between the first and second electrode layers. In otherwise, the first and second touch electrodes may be simultaneously formed in a same electrode layer. If so, the bridges of the second direction touch electrodes may be provided by a conductive pattern in a separate layer and be electrically connected to the island pads on the second direction touch electrode through contact holes.

In one specific example, each of the island pads has a square shape, except along a fringe of the touch-screen area; and a side length of the island pad may be within a range from 1 to 10 mm, more specifically from 1.5 to B mm, or from 2 to 6 mm for example. The gaps between the island pads, the widths of the dents, and/or the line thicknesses (breadths) of the mesh lines may be within a range from 50 to 1000 μm, or from 100 to 500 μm for example. In a preferable specific example, the gap between the island pads is substantially same with the width of each of the dents and with the line thicknesses of the mesh lines. Hence, the width of each of the dents and the line thickness of each of the mesh lines are within a range from 0.8 to 1.2 times, specifically 0.9 to 1.1 times, of the gap between the island pads.

Disclosures in respect of the embodiments are only for sake of examples, and modifications easily conceivable by a skilled person in the art without departing from the gist of the invention are included in the scope of the invention as a matter of course. For sake of clarity, drawings may be schematically illustrated in terms of width, thickness and shape of the elements and/or parts differently from the reality. Illustrations in the drawings are mere examples, and are not intended to limit the scope of the invention.

### First Embodiment

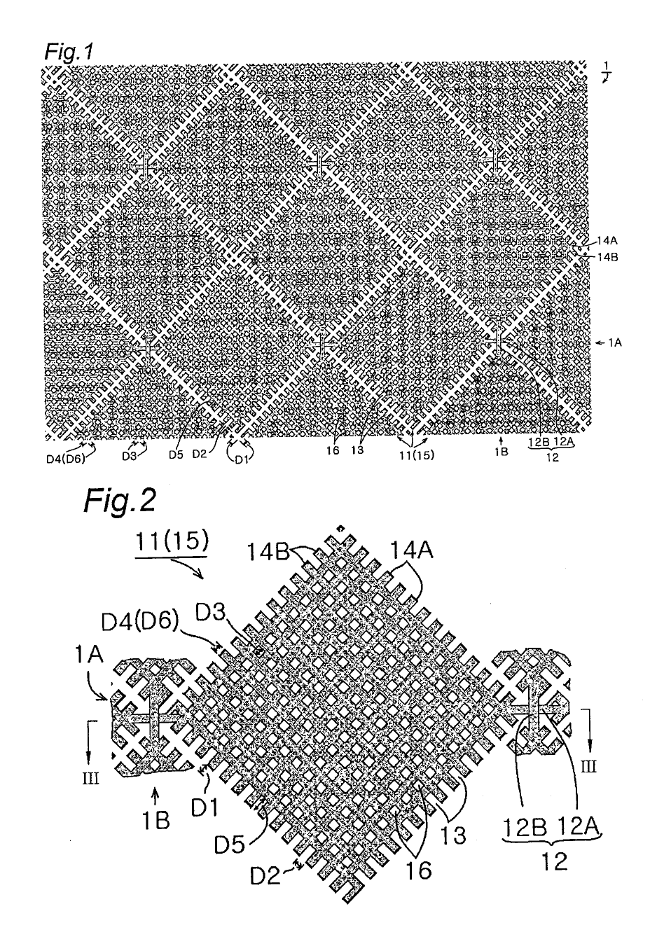

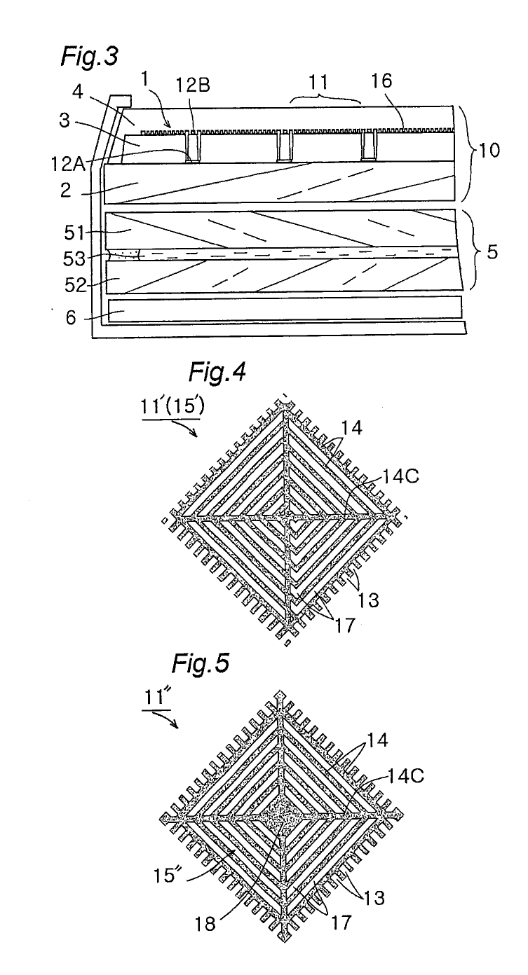

The touch screen of a first embodiment of the invention will be described with reference to FIGS. 1-3. FIGS. 1-2 show a pattern of the touch electrodes, and FIG. 3 shows an example of a laminated construction of the touch screen.

As shown in FIG. 1, a touch electrode pattern 1 comprises: an array of first direction touch electrodes 1A, each extending in a right-left-wise direction of the drawing (X direction); and an array of second direction touch electrodes 1B, each extending in a top-bottom-wise direction of the drawing (Y direction). Each of the touch electrodes 1A and 1B comprises: a plurality of island pads 11 arrayed in a line or a row; and bridges 12, each of which connects two adjacent ones of the island pads 11. In other words, each of the touch electrodes 1A and 1B is constructed in a manner that: the island pads 11 are serially connected by the bridges 12 of a short length dimension, in a form resembling a rosary. At inside of the touch electrode pattern 1, each of the island pads 11 of the first direction touch electrodes 1A is surrounded by four of the island pads 11 of the second direction touch electrodes 1B. In an exactly same manner, each of the island pads 11 of the second direction touch electrodes 1B is surrounded by the island pads 11. In the illustrated example, each of the island pads 11 is shaped as a square, and each of the bridges 12 connect apexes of the squares. Therefore, the island pads 11 forming the touch electrode pattern 1 are arrayed in an orthogonal grid as a whole, and two diagonal lines of the square of the island pad run respectively in the right-left-wise direction (X direction) and the top-bottom-wise direction (Y direction) of the drawing. The right-left-wise direction (X direction) and the top-bottom-wise direction (Y direction) correspond respectively to those of a touch screen panel 10.

As shown in FIGS. 1-2, each of the island pads 11 has a number of dents 13 at a fringe of the pad. Specifically, an outline of each of the island pads 11 is shaped, in substantially whole circumference, as a rectangular wave. In the illustrated specific example, a width D2 of the dents 13 is same as a gap D1 between the island pads 11. In the illustrated example, the gap D1 between the island pads 11 is constant or substantially constant, and accordingly, the width D2 of the dents 13 is constant or substantially constant, throughout the touch electrode pattern 1. A distance D6 between the dents 13 is substantially the same as the gap D1 between the island pads 11 and the width D2 of the dents 13. Meanwhile, a depth D5 of the dents is in a range from 1.5 to 2.5 times of the width D2 of the dents 13.

Throughout each of the island pads 11, there is formed a single mesh pattern 15; and non-slit mesh openings 16 are arrayed in the non-fringe part or interior of the island pads 11. A width (a dimension of each side of a square shape of the opening in the illustrated example) D3 of the opening 16 is substantially the same as the gap D1 between the island pads 11 and as the width D2 of the dents 13. In the illustrated specific example, the mesh pattern 15 is constructed such that: straight mesh lines 14 having an identical width D4 are combined to form an orthogonal grid. In other words, an array of first-oblique-direction mesh lines 14A, each extending in a direction along one side of the square of the island pad 11, are orthogonally combined with an array of second-oblique-direction mesh lines 14B, each extending in a direction along an adjacent side of the square, so as to form the mesh pattern 15. Therefore, the width D4 of the mesh lines 14 is equal to the distance D6 between the dents 13 and the width D3 of the mesh openings 16. In a specific example, one side of the square of the island pads 11 is 7 mm; and 10 μm is each of: the gap D1 between the island pads 11, the width D2 of the dents 13 and the width D4 of the mesh lines 14.

In an example of a laminated construction illustrated in FIG. 3, a wiring formed of a metal or the like is formed on a transparent insulation substrate 2; and the touch electrode pattern 1 formed of a transparent conductive material such as ITO is formed on a resin insulation film 3, which is a planarization film and covers the wiring. Nevertheless, X-direction bridges 12A are formed of a metal or the like and provided on the transparent insulation substrate 2; and ends of each of the bridges 12A are respectively connected to tips of two of the island pads 11 via contact holes. The layer of the touch electrode pattern 1 is covered with a robust cover layer 4 formed by a curable resin such as urethane acrylate. In the illustrated embodiment, the touch screen panel 10 is manufactured separately from a display panel 5, and is an “external” one, which is to be mounted on a view-area face of the display panel 5. In the illustrated specific example, the display panel 5 is a transmissive LCD panel equipped with a backlight 6, and comprises a counter substrate 51 and an array substrate 52, which are formed of a transparent insulation substrate and adhered to each other, as well as a liquid crystal layer 53 interposed between the substrates 51 and 52.

According to the first embodiment, edges of the island pad formed of the transparent conductive material would become not visible from user while maintaining detection sensitivity and its reliability, based on detecting a change in electrostatic capacitance, for touches by finger or pen. Due to presence of the dents in a manner of rectangular wave at the fringe of the island pad, an outline of the island pad formed of the transparent conductive material becomes blurry and would become hardly visible. Moreover, the mesh openings are arrayed in the interior of the island pad in a manner corresponding to an array of the dents; and thus, an area having the dents and the gaps between the island pads would have only a very small difference in appearance from other areas.

In the illustrated specific example, a ratio of a total area of the dents and the openings to a circumscribed square area, which is obtained by connecting protruded ends of the island pad, is within a range from 25 to 30%. The dents and the openings have relatively small widths and thus would make no substantial influence on the electrostatic capacitance of the island pad and thereby make no influence on touch detection sensitivity. Moreover, the dents have relatively small depths; and thus dented fringe would not act as antenna and thereby not generate a noise.

In the first embodiment, the dents are described to be arrayed equidistantly. Nevertheless, the distance between the dents may be gradually increased or decreased, or may be increased and decreased repeatedly, as it goes along a fringe of the pad away from a tip of the pad such as an apex of the square shape of the pad. The width D2 of the dents 13 may also be gradually increased, decreased or fluctuated as it goes along the fringe away from the tip. Shape of the mesh openings 16 may not only be a square shape, but also be either of: a rounded rectangular shape having an aspect ratio (length-to-width ratio) of 3 or smaller, a rectangular shape, a circular shape and an oval shape, for examples. Short diameter or the width D3 of the mesh openings 16 does not have to be constant. For example, the widths of the mesh openings may be decreased, and/or distribution density of the mesh openings may be gradually decreased, with increase of distance from the fringe of the island pads 11 by approaching to the centers of the island pads 11. In FIGS. 1-2, the rectangular-wave-shaped dents 13 are arranged as line-symmetrical about a centerline of the gaps between the island pads 11. Nevertheless, in order to further reduce the visibility of the dents 13, it would be preferable to adopt a staggered arrangement about the centerline of the gap, between arrays of the dents on one and another of the island pads.

### Second Embodiment

FIG. 4 shows an essential portion of the touch screen according to a second embodiment, by illustrating only a single island pad.

According to the second embodiment, slit openings 17 are arrayed in the non-fringe part of each of the island pads 11′, instead of the non-slit mesh openings. In other words, throughout the island pad 11′, arranged is a mesh pattern 15′ formed of the dents 13 and the slit openings 17. Specifically, the mesh pattern 15′ comprises: mesh lines 14, each extending in parallel to a nearby edge of the island pad; and two diagonal mesh lines 14C, each extending along diagonal lines (in X, Y directions) of the square of the island pad; and inside of an outermost square-frame mesh line 14 at just inside of the dents 13 is divided by the diagonal mesh lines 14C to four regions, in each of which stripe-wise mesh lines 14 and slit openings 17 are arrayed in parallel with each other.

In the illustrated specific example, the stripe-wise mesh lines 14 and the slit openings 17 are constructed such that: a single helical mesh line runs in a manner of one-stroke sketch, from a center portion to the fringe of the island pad 11′, by being bent at right angle at every intersection with the diagonal mesh lines 14C. The line thickness or width of the mesh lines 14 is substantially constant throughout the mesh pattern 15′; and the width of the slit openings 17 is substantially the same as the line thickness of the mesh lines 14. Therefore, a ratio of total area of the openings 17 and the dents 13 to the circumscribed square area of the island pad 11′ is within a range from 40 to 50%.

### Third Embodiment

FIG. 5 shows an essential portion of the touch screen according to a third embodiment, by illustrating only a single island pad as in FIG. 4.

In the third embodiment, each of the island pad 11″ is formed of: a central solid portion 18 having no opening; and a mesh pattern 15″ in remaining part. In this mesh pattern 15″ as well, the mesh lines 14 and the slit openings 17 run in parallel to the nearby edge of the island pad, as arranged in stripes in each of areas partitioned by the diagonal mesh lines 14C. Here, the mesh lines 14 are arranged in line-symmetrical about the diagonal mesh lines 14C; and four of the mesh lines 14 running respectively parallel with the edges of the pads forms a square shape, in a manner that a single mesh line is bent at right angle at every intersection with the diagonal mesh lines 14C.

In the illustrated specific example, the central solid portion 18 has a square shape and is arranged concentrically and in same orientation with the circumscribed square area of the island pad 11″. Side length or a dimension of the central solid portion 18 is within a range from ¼ to ⅓ of side length of the island pad in a square shape, or of a corresponding dimension of the circumscribed square area. A ratio of total area of the openings 17 and the dents 13 to the circumscribed square area is within a range from 35 to 45%.

Substantially same advantages are achievable by the embodiments shown in FIGS. 4-5, in which slit openings are arranged in parallel with the nearby edge of the island pad, as in the embodiment shown in FIGS. 1-2, in which non-slit mesh openings are arranged. While the slit openings are presented to be parallel to the nearby edge in the above embodiments, the slits may run obliquely to the nearby edge, and non-slit openings along with the slit openings may be arranged. Meanwhile, the central solid part 18 as in the third embodiment may be arranged in the island pad of the second embodiment or of the first embodiment.

While each of the island pads is presumed to be shaped as a square in above explanations of detailed embodiments, or the first through third embodiments, except along a fringe of the touch-screen area; each or most or some of the island pads may be shaped as rhombic, rhomboidal, rectangular or hexagonal and still have substantially same construction of the dents and/or the openings as in the above. In such island pads, an angle between adjacent ones of the mesh lines or the slit openings as well as vertex angle of the island pad are not necessarily be right angle.

What is claimed is:

1. A touch screen comprising, in a touch screen area:
an array of first direction touch electrodes, each extending in a first direction; and
an array of second direction touch electrodes, each extending in a second direction, which intersect the first direction touch electrode;
each of the touch electrodes comprising a plurality of island pads and a plurality of bridges that serially connects the island pads;
each of the island pads having dents on a fringe as shaped as a rectangular wave;
a width of each of the dents and a distance between the dents are 0.5 to 1.5 times of a gap between adjacent ones of the island pads; and
a depth of the dents being 1 to 3.5 times of the gap between the adjacent ones of the island pads.

2. The touch screen according to claim 1, wherein
each of the island pads comprises a mesh pattern at least in vicinity of a fringe of the island pad;
a width of each of openings in the mesh pattern being 0.25 to 1.3 times of a gap between the adjacent island pads; and
thickness of lines in the mesh pattern being 0.5 to 1.5 times of a gap between the adjacent ones of the island pads.

3. The touch screen according to claim 2, wherein
the mesh pattern comprises non-slit mesh openings and/or slit openings.

4. The touch screen according to claim 2, wherein
the island pad comprises a central solid part and a mesh pattern surrounding the central solid part.

5. A display device having the touch screen according to claim 1.
